(19) United States
(12) Patent Application Publication
(10) Pub. No.: US 2010/0019586 A1
(43) Pub. Date: Jan. 28, 2010

(54) EXTERNAL ROTOR MOTOR

(75) Inventor: Chuping LU, Zhongshan (CN)

Correspondence Address: MATTHIAS SCHOLL, 14781 MEMORIAL DRIVE, SUITE 1319, HOUSTON, TX, 77079, US

(73) Assignee: Zhongshan Broad-Ocean Motor Co., Ltd., Zhongshan (CN)

(21) Appl. No.: 12/490,693

(22) Filed: Jun. 24, 2009

(30) Foreign Application Priority Data
Jun. 26, 2008 (CN) 200810029146.3

(51) Int. Cl. H02K 1/04; H02K 21/22

(52) U.S. Cl. 310/43; 310/153

(57) ABSTRACT

An external rotor motor, composed of at least a stator with a stator core, coil winding, and insulating housing; a rotor; a plurality of bearings; and a rotating shaft. The rotor is disposed outside the stator and connected to the rotating shaft. The rotating shaft is disposed on the stator via the bearing. The coil winding is wrapped on the stator core. The stator core and the coil winding are disposed in the insulating housing. The external rotor motor of the invention is waterproof and dustproof; does not oxidize easily; features good insulation performance and integrity, light weight, and low cost; and is easy to manufacture.

### CROSS-REFERENCE TO RELATED APPLICATIONS

Pursuant to 35 U.S.C. § 119 and the Paris Convention Treaty, this application claims the benefit of Chinese Patent Application No. 200810029146.3 filed on Jun. 26, 2008, the contents of which are incorporated herein by reference.

### BACKGROUND OF THE INVENTION

1. Field of the Invention

The invention relates to an electric motor, and more particularly to an external rotor motor.

2. Description of the Related Art

A conventional external rotor motor has an end cover, stator core, coil winding, and an insulator. The coil winding is wrapped around the stator core, the insulator is disposed on the coil winding, and the stator is fit with the end cover. A bearing housing supports the rotation of the motor. The stator is fixed to the end cover with a screw.

However, there are several disadvantages to this construction. First, the motor is not waterproof, or dustproof, and oxidizes easily. Second, the motor features poor insulation performance and integrity, has a relatively high weight, and is costly and inefficient to construct. Third, the production of the bearing housing is complex and the dimensional precision thereof is low.

### SUMMARY OF THE INVENTION

In view of the above-described problem, it is one objective of the invention to provide an external rotor motor that is waterproof and dustproof, does not oxidize easily, features good insulation performance and integrity, is light weight, low cost, is easy to produce and allows for high production efficiency.

To achieve the above objectives, in accordance with one embodiment of the invention, provided is an external rotor motor, comprising a stator, a rotor, a plurality of bearings, and a rotating shaft, wherein the stator comprises a stator core, a coil winding, and an insulating housing; the rotor is disposed outside the stator and connected to the rotating shaft, the rotating shaft is disposed on the stator via the bearing, the coil winding is wrapped on the stator core, and the stator core and the coil winding are disposed in the insulating housing.

In a class of this embodiment, a protruding portion is axially extended from one end of the insulating housing.

In a class of this embodiment, a plurality of inserting portions is disposed in the protruding portion.

In a class of this embodiment, a screw hole is disposed in the inserting portion and is adapted to receive a screw whereby fixing the stator.

In a class of this embodiment, an information display portion is disposed on one end of the protruding portion.

In a class of this embodiment, an axial hole is disposed at the center of the insulating housing.

In a class of this embodiment, a pair of bearing housings is formed one on each end of the axial hole.

In a class of this embodiment, the bearing is disposed in the bearing housing.

In a class of this embodiment, the rotating shaft is disposed on the insulating housing via the bearing.

In a class of this embodiment, a lead clamp is disposed on the insulating housing.

In a class of this embodiment, wires on one end of the coil winding are led from the insulating housing via the lead clamp.

In a class of this embodiment, the insulating housing is made from injection-molded or die-cast bulk molding compounds.

In a class of this embodiment, the insulating housing is made from injection-molded or die-cast-molded thermoplastic insulating materials.

In a class of this embodiment, the insulating housing is made from injection-molded or die-cast-molded thermosetting insulating materials.

In accordance with another embodiment of the invention, provided is an external rotor motor, comprising a stator; said stator comprising a stator core, a coil winding, and an insulating housing; a rotor; a plurality of bearings; a rotating shaft; and a protruding portion, wherein the rotor is disposed outside the stator and connected to the rotating shaft, the rotating shaft is disposed on the stator via the bearing, the coil winding is wrapped around the stator core, the stator core and the coil winding are disposed in the insulating housing, and the protruding portion is axially extended from one end of the insulating housing.

In a class of this embodiment, an axial hole is disposed at the center of the insulating housing.

In a class of this embodiment, a pair of bearing housings is formed one on each end of the axial hole.

In a class of this embodiment, the bearing is disposed in the bearing housing.

In a class of this embodiment, the rotating shaft is disposed on the insulating housing via the bearing.

Advantages of the invention include:
1) the protruding portion and the insulating housing are integrally formed so as to fix the stator, and no end cover is needed, whereby facilitating simple structure and easy production and assembling of the invention, and reducing production cost;
2) the bearing housings are injection formed, feature high precision, improve production efficiency, ensure assembly accuracy of the motor and require no machining process;
3) the inserting portions and the screw holes disposed therein facilitate simple structure and easy installation;
4) wires on one end of the coil winding are led from the insulating housing via the lead clamp, which facilitates simple structure and easy installation; and
5) the insulating housing is made from injection-molded or die-cast-molded bulk molding compounds, thermoplastic insulating materials or thermosetting insulating materials, which reduces weight and temperature rise of the motor, and improves heat dissipation effect of the stator.

### BRIEF DESCRIPTION OF THE DRAWINGS

The invention is described hereinafter with reference to accompanying drawings, in which:

FIG. 1 is a cross-sectional view of an external rotor motor of an exemplary embodiment of the invention; and

FIG. 2 is a schematic view of an external rotor motor of an exemplary embodiment of the invention.

### DETAILED DESCRIPTION OF THE EMBODIMENTS

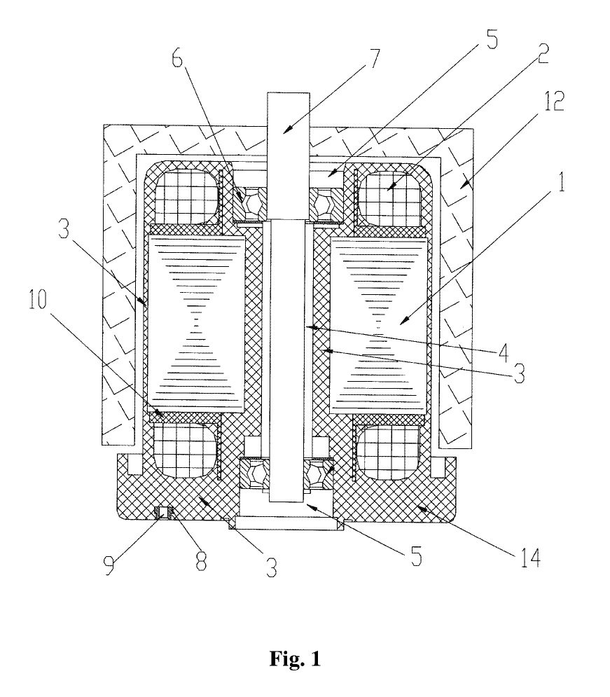

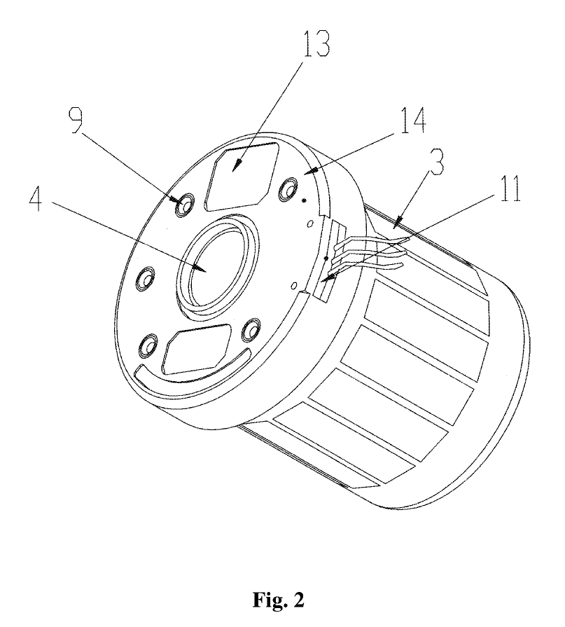

As shown in FIGS. 1 and 2, an external rotor motor of the invention comprises a stator, a rotor 12, a plurality of bearings 6, and a rotating shaft 7. The stator comprises a stator core 1, a coil winding 2, and an insulating housing 3.

The rotor 12 is disposed outside the stator and connected to the rotating shaft 7.

The rotating shaft 7 is disposed on the insulating housing 3 via the bearing 6.

The coil winding 2 is wrapped on the stator core 1, and the stator core 1 and the coil winding 2 are disposed in the insulating housing 3.

A protruding portion 14 extends axially from one end of the insulating housing 3. A plurality of inserting portions 8 is disposed in the protruding portion, and a screw hole 9 is disposed in the inserting portion 8 and is adapted to receive a screw whereby fixing the stator.

An axial hole 4 is disposed at the center of the insulating housing 3, and a pair of bearing housings 5 is formed one on each end of the axial hole 4. The bearing 6 is received in the bearing housing 5.

An insulator is disposed on one end of the stator core 1, and is adapted to separate the stator 1 from the coil winding 2.

A lead clamp 11 is disposed on the insulating housing 3, and wires on one end of the coil winding 2 are led from the insulating housing 3 via the lead clamp 11.

An information display portion 13 is disposed on the protruding portion 14, and is adapted to display information such as the manufacturer of the motor, rated parameters, safety information, etc.

In this embodiment, the insulating housing 3 is made from injection-molded or die-cast-molded bulk molding compounds, thermoplastic insulating materials, or thermosetting insulating materials.

The protruding portion 14 is adapted to fix the stator, and no end cover is needed, whereby facilitating simple structure and easy production and assembling of the invention, and reducing production cost.

The bearing housings 5 are injection formed, feature high precision, improve production efficiency, ensure assembly accuracy of the motor, and require no machining process.

The inserting portions 8 and the screw holes 9 disposed therein facilitate simple structure and easy installation and are capable of providing waterproof structure whereby preventing corrosion and improving safety and reliability of the motor.

Wires on one end of the coil winding 2 are led from the insulating housing 3 via the lead clamp 11, which facilitates simple structure and easy installation.

The insulating housing 3 is made from injection-molded or die-cast-molded bulk molding compounds, thermoplastic insulating materials, or thermosetting insulating materials, which reduces weight and temperature of the motor, and improves heat dissipation effect of the stator.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An external rotor motor, comprising
a stator comprising a stator core, a coil winding, and an insulating housing;
a rotor;
a plurality of bearings; and
a rotating shaft;
wherein
said rotor is disposed outside said stator and connected to said rotating shaft;
said rotating shaft is disposed on said stator via said bearing;
said coil winding is wrapped around said stator core; and
said stator core and said coil winding are disposed in said insulating housing.

2. The motor of claim 1, wherein a protruding portion is axially extended from one end of said insulating housing.

3. The motor of claim 2, wherein a plurality of inserting portions are disposed in said protruding portion.

4. The motor of claim 3, wherein a screw hole is disposed in said inserting portion and is adapted to receive a screw whereby fixing said stator.

5. The motor of claim 2, wherein an information display is disposed on one end of said protruding portion.

6. The motor of claim 1, wherein an axial hole is disposed at the center of said insulating housing.

7. The motor of claim 6, wherein a pair of bearing housings is formed one on each end of said axial hole.

8. The motor of claim 7, wherein said bearing is disposed in said bearing housing.

9. The motor of claim 8, wherein said rotating shaft is disposed on said insulating housing via said bearing.

10. The motor of claim 1, wherein a lead clamp is disposed on said insulating housing.

11. The motor of claim 10, wherein wires on one end of said coil winding are led from said insulating housing via said lead clamp.

12. The motor of claim 1, wherein said insulating housing is made from injection-molded or die-cast bulk molding compounds.

13. The motor of claim 1, wherein said insulating housing is made from injection-molded or die-cast thermoplastic insulating materials.

14. The motor of claim 1, wherein said insulating housing is made from injection-molded or die-cast thermosetting insulating materials.

15. An external rotor motor, comprising
a stator comprising a stator core, a coil winding, and an insulating housing;
a rotor;
a plurality of bearings;
a rotating shaft; and
a protruding portion;
wherein
said rotor is disposed outside said stator and is connected to said rotating shaft;
said rotating shaft is disposed on said stator via said bearing;
said coil winding is wrapped around said stator core;
said stator core and said coil winding are disposed in said insulating housing; and
said protruding portion extends axially from one end of said insulating housing.

16. The motor of claim 15, wherein an axial hole is disposed at the center of said insulating housing.

17. The motor of claim 16, wherein a pair of bearing housings is formed one at each end of said axial hole.

18. The motor of claim 17, wherein said bearing is disposed in said bearing housing.

19. The motor of claim 18, wherein said rotating shaft is disposed on said insulating housing via said bearing.
